(19) United States
(12) Patent Application Publication
(10) Pub. No.: US 2005/0163951 A1
(43) Pub. Date: Jul. 28, 2005

(54) Device produced using an injection molding method and provided for storing liquids, and method for producing this device

(76) Inventors: Markus Oles, Hattingen (DE); Edwin Nun, Billerbeck (DE); Bernhard Schleich, Recklinghausen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/506,236

(22) PCT Filed: Feb. 3, 2003
(86) PCT No.: PCT/EP03/01026

(30) Foreign Application Priority Data
Mar. 12, 2002 (DE) 102 10 668.1

(51) Int. Cl. B32B 1/00

(52) U.S. Cl. 428/35.7; 264/255; 264/328.1; 428/143

(57) ABSTRACT

The invention relates to devices produced by injection molding for storing and/or handling liquids, which can be emptied without residues, and also to a simple process for producing such devices. Liquids are frequently taken up and distributed in a defined manner using pipette tips, syringes, ampoules or similar devices. However, for technical reasons, the pipette tips available on the market today cannot pipette the smallest volumes desired without contact, i.e. provide unaided and complete release of the liquid to be pipetted from the pipette tip. Equally, it is currently impossible to completely empty storage vessels. The devices according to the invention overcome this problem by the surfaces which come into contact with the liquid being provided with self-cleaning properties. This makes it possible to take up and distribute liquids without residue in a simple manner and to completely empty storage vessels. The process according to the invention is very simple since it can use existing equipment. Customarily, injection-molded parts are produced by means of injection molds into which the material is injected. The process according to the invention uses this process by applying microparticles to the injection mold before the actual injection molding, these being transferred to the injection-molded part on injection molding by being impressed into the surface of the injection-molded part.

The invention relates to devices produced by means of injection molding for storing liquids, which can be emptied of the stored liquids without any residue, and also to a process for preparing them.

To take up liquids in a defined manner and distribute them, pipette tips or similar tools are frequently used. With the aid of these pipette tips, liquids can be withdrawn from a supply vessel or defined amounts of liquid can be transferred from one container to another. In molecular biology, high throughput screening or combinatorial chemistry, ever smaller volumes are pipetted. However, for technical reasons, the pipette tips currently available on the market cannot pipette the smallest volumes desired without contact, i.e. provide unaided and complete release of the liquid to be pipetted from the pipette tip. For technical reasons, a pipette tip is desired which allows volumes <500 nl to be pipetted without contact.

From the fields of adhesive technology and inkjet technology, processes are known by which very small droplets can be applied to a surface. DE 2819440 describes a process in which liquid is conveyed to the discharge nozzle from a supply vessel disposed above the discharge nozzle via a tube line. Droplets forming at the orifice are stripped away using a pressurized gas pulse. This process can also be utilized to strip away a liquid droplet from a pipette tip and offers the advantage of allowing very small droplets to be applied to a surface. A disadvantage of the process is the poor reproducibility of the droplet size and that the pressurized pulse can also expel liquid from the reaction vessel.

From another technical field, the biolbgical/pharmaceutical industry, the problem of packaging biological or pharmaceutical products—usually in solution—and the complete undiluted withdrawal of these solutions from the packaging is known. Typical packagings are plastic ampoules with or without seals. Frequently, valuable biological or pharmaceutical products are also packaged in very small amounts. This is on the one hand due to the high effectiveness of these preparations and on the other hand to the very high price of these substances. Volumes of less than 100 μl are not exceptional. It can be observed that such solutions and preparations can usually only be withdrawn incompletely from these containers. This is problematic in many different respects, for example because the containers can only be disposed of as hazardous waste or because the amount specified on the container cannot be administered precisely, so that either less than the specified, and therefore usually also the prescribed, amount of preparation is administered or, in order to apply the prescribed amount, a further container has to be opened with the disadvantage that a relatively large remainder of expensive preparation has to be discarded.

From surface technology, various processes for: treating surfaces are known which make these surfaces dirt- and water-repellent. For example, it is known that to achieve good self-cleaning of a surface, in addition to a hydrophobic surface, the surface also has to have a certain roughness; A suitable combination of structure and hydrophobicity makes it possible for even small amounts of moving water on the surface to entrain adhering dirt particles and to clean the surface (WO 96/04123; U.S. Pat. No. 3,354,022). The fact that water droplets roll off hydrophobic surfaces particularly when they are structured was described as early as 1982 by A. A. Abramson in Chimia i Shisn russ. 11, 38.

Articles having liquid-repellent, i.e. difficult-to-wet surfaces, have a series of interesting and economically important features. For instance, they are easy to clean and have little tendency to retain to residues and liquids.

The prior art of EP 0 933 388, with regard to self-cleaning surfaces is that an aspect ratio of >1 and a surface energy of less than 20 mN/m are required for such self-cleaning surfaces. The aspect ratio is defined as the quotient of the average height to the average width of the structure. The abovementioned criteria are realized in the natural world, for example in the lotus leaf. The plant surface, formed of a hydrophobic waxy material, has elevations separated from each other by a few μm. Water droplets come into contact substantially only with these peaks. Such water-repellent surfaces have been described many times in the literature. An example thereof is an article in Langmuir 2000, 16, 5754 by Masashi Miwa et al. which describes that contact angle and roll-off angle increase with increasing structuring of artificial surfaces formed from boehmite, applied to a spin-coated layer and then calcined.

The Swiss patent CH-PS 268258 describes a process in which structured surfaces are generated by applying powders such as kaolin, talc, clay or silica gel. The powders are secured to the surface using oils and resins based on organosilicon compounds.

The use of hydrophobic materials such as perfluorinated polymers for producing hydrophobic surfaces is known. DE 197 15 906 A1 describes generation of hydrophobic surfaces which are structured and have low adhesion toward snow and ice from perfluorinated polymers such as polytetrafluoroethylene or copolymers of polytetrafluoroethylene with perfluoroalkyl vinyl ethers. JP 11171592 describes a water-repellent product and its production in which the dirt repellent surface is prepared by applying, to the surface to be treated, a film which comprises fine particles of metal oxide and the hydrolysate of a metal oxide or a metal chelate. To secure this film, the substrate to which the film has been applied has to be sintered at temperatures of above 400° C. This process can therefore only be used for substrates which can be heated to temperatures of above 400° C.

WO 00/58410 comes to the conclusion that it is technically possible to artificially make surfaces of articles self-cleaning. The surface structures composed of elevations and depressions necessary for this purpose have a separation between the elevations of the surface structures in the range from 0.1 to 200 μm and a height of the elevations in the range from 0.1 to 100 μm. The materials used for this purpose have to consist of hydrophobic polymers or permanently hydrophobicized material. Release of the particles from the carrier matrix has to be prevented. The use of hydrophobic materials such as perfluorinated polymers for producing hydrophobic surfaces is known. A further development of these surfaces consists in structuring the surfaces in the μm range to nm range. U.S. Pat. No. 5,599,489 discloses a process by which a surface can be made particularly repellent by bombardment with particles of an appropriate size and subsequent perfluorination. Another process is described by H. Saito et al. in “Service Coatings International”, 4, 1997, p. 168 ff. Here, particles of fluoropolymers are applied to metal surfaces thereby producing a greatly reduced wettability of the resultant surfaces toward water with a considerably reduced tendency to icing.

The customary processes hitherto for producing self-cleaning surfaces are costly and inconvenient and in many cases only of limited utility. For instance, embossing techniques are inflexible with regard to applying structures to three-dimensional bodies of varying shape. There is currently still no suitable technology for generating planar coating films of large surface area. Processes in which structure-forming particles are applied to surfaces by means of a carrier—for example an adhesive—have the disadvantage that surfaces of highly differing material combinations are obtained which for example when subjected to thermal stress have different expansion coefficients, and this can lead to damage to the surface.

Processes for producing these structured surfaces are likewise known. As well as processes employing a masterstructure to mold these structures in full detail by injection molding and embossing, processes are also known which utilize the application of particles to a surface (U.S. Pat. No. 5,599,489).

DE 29919506 U1 describes the application of the processes mentioned to microstructure the surfaces of pipette tips. The production of microstructured pipette tips is based here on a process from microsystem technology. The structured surface necessary for the process is already known from another technical field. The surfaces are self-cleaning surfaces. Processes for preparing them are disclosed, for example, in DE 19803787 and DE 19914007. The processes disclosed in these documents are used in DE 29919506 to produce pipette tips. The disadvantage of this process is the relatively inconvenient and cost-intensive production process.

It is therefore an object of the present invention to provide devices for storing liquids, in particular pipette tips, syringes and storage vessels with which liquids can be taken up in a simple manner without residue and withdrawn without residue. These devices should be capable of production by means of a simple process which in particular can be integrated without great cost or inconvenience into the normal production process. Surprisingly, it has been found that the application of hydrophobic nanostructured particles to an injection mold and subsequent injection of an injection molding using this injection mold allows the particles to be firmly integrated into the surface of the injection molding and that, when these injection moldings are used as devices for storing liquids, for example pipettes, pipette tips, syringes or storage vessels, it is possible to use such devices to store even the smallest amounts of liquid Without residue and to remove them from the device without residue.

The present invention provides devices produced by means of injection molding processes for storing and/or handling liquids, which can be emptied of the stored liquids without residue which are characterized in that the device has at least one surface which comes into contact with the liquid to be stored and has a firmly anchored layer of microparticles which form elevations.

The invention likewise provides a process for producing, by injection molding, devices according to the invention as injection moldings having at least one surface which has self-cleaning properties and has elevations formed by microparticles characterized in that microparticles are applied to an injection mold before an injection molding step and an injection molding step is then carried out in which the microparticles are impressed into the surface of the injection molding.

The process according to the invention for producing devices for storing liquids by injection molding has the advantage that it can use existing equipment for the production of injection moldings. Customarily, injection-molded parts are produced by means of injection molds into which the material is injected. The process according to the invention uses this process by applying microparticles to the injection mold before the actual injection molding, these being transferred to the injection-molded part, and thus to the device, on injection molding by being impressed into the surface of the device. In this simple manner, devices having self-cleaning surfaces are obtainable which comprise particles having a fissured structure without an additional embossed layer or carrier layer of a different material having to be applied to the injection molding, and can be emptied without residue.

Since the device has at least one surface with which the liquid to be stored comes into contact and which has a firmly anchored layer of microparticles which form elevations and are therefore, particularly when the elevations are hydrophobicized, difficult to wet with water or aqueous solutions, when the devices are used for storing products in aqueous solution, they can be emptied without residue, i.e. completely. This is advantageous in many different respects, for example because the containers can then be disposed of normally as domestic refuse and not as hazardous waste or because the entire amount of a preparation in for example a reaction vessel or a plastic ampoule can be administered. In this way, large amounts of expensive preparations can be saved, and the dosing accuracy of medicaments can be distinctly improved.

The devices according to the invention have the advantage that the structure-forming particles are not secured by a carrier material and therefore, thus avoiding any unnecessarily high number of material combinations and the resulting negative properties.

When the devices according to the invention are pipette tips, these, like the pipette tips described in the prior art, have the advantage that, when pipetting, no liquids remain on the pipette tip (depending on the design either on the inside or the outside). When taking up liquids with the pipette tip according to the invention, there is no adherence of liquid to the exterior of the pipette tip and no liquid residues remain in the interior of the pipette after emptying the pipette tip. In this way, the transfer of impurities from the stock solution to other containers is avoided. Also, substantially more accurate pipetting is possible since only the desired volume is transferred. However, in comparison to the prior art processes, the pipette tips are distinctly simpler to produce.

The pipette tips according to the invention and produced by the process according to the invention thus have the following advantages:
usable even for liquid amounts of less than 1 μl
no use of pressurized pulses
no use of antimicrobicidal materials
no entrainment of reaction media when immersing, for example, pipette tips or capillary tips into liquids by residues of these liquids
high volume accuracy
high reproducibility

The devices according to the invention produced by means of injection molding processes for storing and/or handling liquids, which can be emptied of the stored liquids without residue are notable in that the device has at least one surface which comes into contact with the liquid to be stored and has a firmly anchored layer of microparticles which form elevations. This surface has liquid-repellent properties.

The firmly anchored layer of microparticles is obtained by applying microparticles as a layer to the injection mold before the injection molding and then carrying out injection molding using this mold. On injection molding, the microparticles are at least partially impressed into the injection-molded composition and, when the injection-molded composition sets, are retained by it and therefore anchored. Particularly stable anchoring is obtained when microparticles are used which have a fine structure on the surface, since the fine structure is partially filled in by the injection-molded composition and, once the injection-molded composition has set, many anchoring points are available. For the purposes of the present invention, a layer of microparticles is an accumulation of micro-particles on the surface which form elevations. The layer may be configured in such a way that the surface comprises exclusively microparticles, almost exclusively microparticles or else microparticles at a separation of from 0 to 10, in particular from 0 to 3, particle diameters.

Particularly when the surface has been provided with hydrophobic properties, it is difficult to wet with water or aqueous solutions and therefore has self-cleaning properties, since impurities can be removed by moving water. Storage, in particular temporary storage, can be regarded as a specific type of handling. When handling liquids by means of a device, for example using a pipette or pipette tip, the liquid is customarily stored temporarily in the device, and, for this reason, handling may be regarded for the purposes of the present invention as meaning temporary storage and the terms may therefore be considered equivalent.

The devices according to the invention having surfaces which have liquid-repellent properties and have surface structures having elevations are notable in that the surfaces are preferably synthetic polymer surfaces into which the microparticles are directly incorporated and have not been bound via carrier systems or the like.

The material of the devices themselves is preferably a polymer based on polycarbonates, polyoxymethylenes, poly(meth)acrylates, polyamides, polyvinyl chloride (PVC), polyethylenes, polypropylenes, polystyrenes, polyesters, polyether sulfones, aliphatic linear or branched polyalkenes, cyclic polyalkenes, polyacrylonitrile or polyalkylene terephthalates, or else is a mixture or copolymer thereof. The material of the injection moldings more preferably comprises a material selected from poly(vinylidene fluoride), poly(hexafluoropropylene), poly(perfluoropropylene oxide), poly-(fluoroalkyl acrylate), poly(fluoroalkyl, methacrylate), poly(vinyl perfluoroalkyl ether) or comprises another polymer of perfluoroalkoxy compounds, poly(ethylene), poly(propylene), poly(isobutene), poly(4-methyl-1-pentene) or polynorbornene as a homo- or copolymer. The material for the surface of the injection moldings is most preferably poly(ethylene), poly(propylene), polymethyl methacrylates, polystyrenes, polyesters, acrylonitrile-butadiene-styrene terpolymers (ABS) or poly(vinylidene fluoride).

The surfaces having liquid-repellent properties preferably have elevations which are formed by the microparticles anchored to the surface with an average height of from 20 nm to 25 μm and an average separation of from nm to 25 μm, preferably with an average height of from 50 nm to 10 μm and/or an average separation of from 50 nm to 10 μm and most preferably with an average height of from 50 nm to 4 μm and/or an average separation of from 50 nm to 4 μm. Most preferably, the injection moldings according to the invention have surfaces having elevations having an average height of from 0.25 to 1 μm and an average separation of from 0.25 to 1 μm. For the purposes of the present invention, the average separation of the elevations is the separation from the highest elevation of an elevation to the next highest elevation. When the elevation has the shape of a cone, the tip of the cone is the highest elevation of the elevation. When the elevation is a cuboid, the uppermost surface of the cuboid is the highest elevation of the elevation.

The wetting of solids, which also gives a measure of the liquid-repellent behavior, can be described by the contact angle which a water droplet forms with the surface. A contact angle of 0 degree means complete wetting of the surface. The contact angle on solids is generally measured by the sessile droplet method. A droplet of a liquid having a known surface tension is applied by means of a suitable metering system to the solids to be characterized. The outline shape of the liquid droplet is then visually determined. The higher the contact angle, the poorer the wettability of the surface.

The devices according to the invention, in particular pipette tips and storage vessels having liquid-, in particular water-repellent, surfaces preferably have a high aspect ratio of the elevations. The elevations on the surface coming into contact with the liquid preferably have an aspect ratio of the elevations of greater than 0.15. The elevations which are formed by the microparticles themselves preferably have an aspect ratio of from 0.3 to 0.9, more preferably from 0.5 to. 0.8. The aspect ratio is defined as the quotient of the maximum height to the maximum width of the structure of the elevations.

The particles are bonded or anchored onto the surface of the device by impressing the particles into the material of the injection molding during the injection molding process. In order to achieve the aspect ratios mentioned, it is advantageous if at least a portion of the particles, preferably more than 50% of the particles, are preferably only impressed into the surface of the injection molding to up to 90% of their diameter. The surface therefore preferably comprises particles which are anchored with from 10 to 90%, preferably from 20 to 50% and most preferably from 30 to 40%, of their average particle diameter within the surface, and which therefore also have parts of their inherently fissured surface protruding out of the injection moldings. In this way it is ensured that the elevations which are formed by the particles themselves have a sufficiently high aspect ratio of preferably at least 0.15. Another result here is that the firmly bonded particles are very securely bonded to the surface of the device. The aspect ratio is defined as the ratio of maximum height to maximum width of the elevations. According to this definition, a particle which is assumed to have an ideal spherical shape, of which 70% protrudes from the surface of the injection molding, has an aspect ratio of 0.7. It is hereby stated explicitly that the particles according to the invention do not have to have a spherical shape.

The microparticles firmly bonded to the surface with which the liquid comes into contact and forming the elevations on the surface of the device are preferably selected from silicates, minerals, metal oxides, metal powders, silicas, pigments and polymers, very particularly preferably from fumed silicas, precipitated silicas, aluminum oxide, silicon oxide, doped silicates, fumed silicates and pulverulent polymers.

Preferred microparticles have a particle diameter of from 0.02 to 100 μm, more preferably from 0.1 to 50 μm, and most preferably from 0.1 to 30 μm. However, suitable microparticles may also have a diameter of less than 500 nm or be composed of primary particles to give agglomerates or aggregates having a size of from 0.2 to 100 μm.

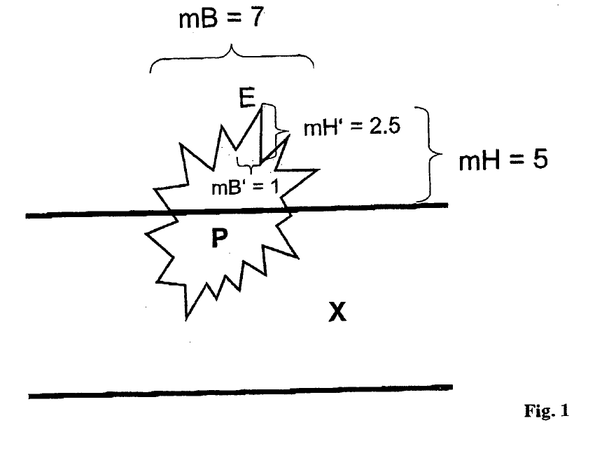

Particularly preferred microparticles which form the elevations of the structured surface are those which have an irregular fine structure in the nanometer range on the surface. The microparticles having the irregular fine structure preferably have elevations having an aspect ratio of greater than 1, more preferably greater than 1.5. The aspect ratio is in turn defined as the quotient of the maximum height to the maximum width of the elevation. FIG. 1 schematically clarifies the difference between the elevations which are formed by the particles and the elevations which are formed by the fine structure. The figure shows the surface of an injection molding X which has particles P (for simplification of the diagram only one particle is shown). The elevation which is formed by the particle itself has an aspect ratio of about 0.71, calculated as the quotient of the maximum height of the particle mH which is 5, since only the portion of the particle which protrudes from the surface of the injection molding X contributes to the elevation and the maximum width mB which in comparison is 7. A selected elevation of the elevations E which are present on the particles as a result of the fine structure of the particles has an aspect ratio of 2.5, calculated as the quotient of the maximum height of the elevation mH′ which is 2.5 and the maximum width mB′ which for comparison is 1.

Preferred microparticles which have an irregular fine structure in the nanometer range on the surface are those particles which comprise at least one compound selected from fumed silicas, precipitated silicas, aluminum oxide, silicon dioxide, fumed and/or doped silicates and pulverulent polymers.

It can be advantageous if the microparticles have hydrophobic properties which may result from the material properties of the materials themselves present on the surfaces of the particles or else be obtained by treating the particles with a suitable compound The microparticles may have been provided with hydrophobic properties before or after the application or binding to or on the surface of the device or of the injection molding.

To hydrophobicize the microparticles before or after application and impression (anchoring) into the surface of the injection molding, these may be treated with a compound suitable for hydrophobicizing, for example from the group of the alkylsilanes, the fluoroalkylsilanes or the disilazanes, as available, for example, with the name Dynasylan from Degussa A G.

Particularly preferred microparticles are illustrated in more detail hereinbelow. The particles may come from various categQries. For example, they may be silicates, doped silicates, minerals, metal oxides, aluminum oxide, silicas or fumed silicas, Aerosils or pulverulent polymers, for example spray-dried and agglomerated emulsions or cryogenically milled PTFE. Useful particle systems are in particular hydrophobicized fumed silicas, known as Aerosils. To generate the self-cleaning surfaces, hydrophobicity is necessary as well as the structure. The particles used may themselves be hydrophobic, for example pulverulent polytetra-fluoroethylene (PTFE). The particles may have been provided with hydrophobic properties, for example Aerosil VPR 411 or Aerosil R 8200. However, they may also be subsequently hydrophobicized. It is unimportant whether the particles are hydrophobicized before application or after application. Examples of such particles to be hydrophobicized include Aeroperl 90/30®, Sipernat silica 350®, Aluminum oxide C®, zirconium silicate, vanadium-doped or VP Aeroperl P 25/20®. In the latter case, the hydrophobicization is advantageously effected by treatment with perfluoroalkylsilane compounds and subsequent heat treatment.

It can be advantageous if the surfaces of the devices which have liquid-repellent properties have elevations applied to an overstructure having an average height of from 10 μm to 1 mm and an average separation of from 10 m to 1 mm.

The surfaces having liquid-repellent properties are preferably hydrophobic, and the unstructured material has a surface energy of less than 35 mN/m, preferably from 10 to 20 mN/m.

It may also be advantageous if the devices according to the invention have not only liquid-repellent surfaces or partial areas thereof but also surfaces or partial areas which have wetting properties. This can be achieved by different surface structures, different interface chemistry or a combination of both in the particular areas, for example:
the liquid-wetting areas have the same surface chemistry but their elevations differ from those of the remaining surface. In this case, the surface chemistry does not differ over the entire surface. Ideally, the liquid-wetting areas have no elevations.
the liquid-wetting and liquid-repellent areas have elevations of the same structure and different surface chemistry. In this case, the liquid-wetting areas have a higher surface energy than the liquid-repellent areas of the surface, determined in each case on unstructured material. Such a configuration of the surface can be achieved, for example, by treating only certain areas with hydrophobicizing agents.

The devices according to the invention are therefore outstandingly suitable for storing biological or pharmaceutical products for which liquids have to be partitioned over small areas and/or the liquid collects on the liquid-wetting areas on gently shaking or gently tilting the vessel.

A further area of application of the devices according to the invention is the field of biotechnology. To adhere to a surface or to multiply on a surface, bacteria and other microorganisms require water, which is not available on the hydrophobic surfaces of the present invention. The structured surfaces of the device according to the invention prevent the growth of bacteria and other microorganisms on the liquid-repellent areas, they are therefore also bacteriophobic and/or antimicrobial. However, the devices which according to the invention have structured (liquid-repellent) and unstructured (liquid-wetting) areas permit, if parameters such as humidity and temperature are appropriate, location-specific growth of bacteria and other microorganisms on the wettable areas. Since the underlying effect is not based on active antimicrobial ingredients but instead on a physical effect, there can be no impairment of the growth of bacteria and other microorganisms on the liquid-wetting areas due to the liquid-repellent areas, for example due to bleeding and/or diffusion of active ingredients.

Surfaces or areas of surfaces according to the invention having liquid-repellent properties have a contact angle with water of preferably greater than 1300, with preference greater than 145°, more preferably greater than 160°. When the devices have surfaces or areas of surfaces having liquid-wetting properties, these preferably have a contact angle with water of preferably less than 25°, more preferably less than 15° and particularly preferably equal to 0°.

As described, the devices may have the elevations on all surfaces coming into contact with the liquid or only on certain surfaces. The devices according to the invention, particularly when they are pipette tips, preferably have elevations applied to the inner surface of the pipette tips, to the outer surface of the pipette tips and/or to the pipette tip outlet. The elevations according to the invention on the outer surfaces of the pipette tips prevent liquid from a supply vessel being transported in the form of drops on the exterior of the pipette tip. The elevations according to the invention on the inner surfaces of the pipette tips prevent liquid remaining in it on expulsion of the liquid from the pipette tip. The elevations according to the invention on the pipette tip outlet distinctly ease the expulsion of the liquid to be pipetted.

Devices according to the invention in the form of pipette tips are suitable in particular for pipetting small volumes. For instance, the pipette tips can be used in particular to pipette volumes of from 10 nl to 10 ml, preferably volumes of from 10 nl to 10 μl, more preferably from 10 nl to 100 nl, from 100 nl to 1 μl or from 1 μl to 10 μl and most preferably from 100 nl to 500 nl. Most preferably, the error in the pipetted volume is less than 20%, preferably less than 10% and most preferably less than 1%.

Preference is given to producing the devices according to the invention by the process according to the invention for producing devices according to the invention as injection moldings having at least one surface which has self-cleaning properties and elevations formed by micrbparticles, which is characterized in that microparticles are applied to an injection mold before an injection molding step and then an injection molding step is carried out in which the microparticles are impressed into the surface of the injection molding, i.e. the device, before it has set. The injection mold is preferably a mold which is customarily used for producing conventional devices. It can be advantageous when the microparticles are not applied to the entire injection mold but instead only to partial areas. In this way, surfaces are obtainable which have different properties in partial areas of the surface.

The impression is preferably effected in such a manner that at least a portion of the particles, preferably at least 50%, with preference 75%, of the particles are only impressed into the surface of the injection molding to a maximum of 90% of their diameter, preferably from 10 to 70%, with preference from 20 to 50% and most preferably from 30 to 40%, of their average particle diameter.

The material used for the process according to the invention may be any polymer suitable for injection molding of injection moldings. The materials used for the injection molding are preferably polymers or polymer blends which comprise a polymer based on polycarbonates, polyoxymethylenes, poly(meth)acrylates, polyamides, polyvinyl chloride, polyethylenes, poly-propylenes, aliphatic linear or branched polyalkenes, cyclic polyalkenes, polystyrenes, polyesters, polyether sulfones, polyacrylonitrile or polyalkylene terephthalates, poly(vinylidene fluoride), poly(hexafluoro-propylene), poly(perfluoropropylene oxide), poly(fluoroalkyl acrylate), poly(fluoroalkyl methacrylate), poly(vinyl perfluoroalkyl ether) or comprise another polymer composed of perfluoroalkoxy compounds, poly(isobutene), poly(4-methyl-1-pentene) or polynorbornene as a homo- or copolymer or mixtures thereof. The materials used for the injection molding are very particularly preferably polymers or polymer blends which comprise a polymer based on poly(ethylene), poly(propylene), polymethyl methacrylates, polystyrenes, polyesters, or comprise acrylonitrile-butadiene-styrene terpolymers (ABS) or poly(vinylidene fluoride).

The microparticles which are impressed into the surface or areas of the surface in the process according to the invention are applied to the surface of the injection mold before impression by the injection molding process. The application may be effected by spraying or scattering, although the application is preferably effected by spraying. The application of the microparticles to the injection mold is advantageous in particular because the micropowder prevents the material of the injection molding from adhering to the mold after the end of the injection molding procedure, since the material itself hardly comes into contact with the mold, if at all, since the microparticles for achieving the preferred separations of the elevations are applied very densely to the mold.

The microparticles can be sprayed onto the mold, for example, by spraying dispersions or aerosols which comprise microparticle powders and which, in addition to the microparticles, comprise a propellant or a preferably volatile solvent, although preference is given to spraying of suspensions. The solvent in the suspensions used is preferably an alcohol, in particular ethanol or isopropanol, a ketone, for example acetone or methyl ethyl ketone, an ether, for example diisopropyl ether, or else a hydrocarbon such as cyclohexane. The suspensions most preferably comprise alcohols. It can be advantageous for the suspension to comprise from 0.1 to 10, preferably from 0.25 to 7.5 and most preferably from 0.5 to 5, % by weight of microparticles, based on the total weight of the suspension. Particularly when spraying a dispersion, it can be advantageous for the injection mold to have a mold surface temperature of from 30 to 150° C. However, depending on the injection molding to be produced and the material used, the temperature of the mold may also have a temperature in the range specified independently of the microparticle powder and of the application of the microparticle powder.

The pressure with which the material is injected into the injection mold is preferably greater than 40 bar, but, like other parameters to be observed on injection molding, for example temperature, depends on the type of polymer used for injection molding and also on the geometry used for the injection molded part. The determination of the injection molding parameters is familiarto those skilled in the art and described in detail, for example, in “Technologie des Spritzengieβen” by W. Michaeli, Hanser 1993 or in “Reaction Injection Molding Machinery and Processes” by F. M. Sweeney, Dekker 1987.

Microparticles used in the process according to the invention are preferably those which comprise at least one material selected from silicas, minerals, metal oxides, metal powders, silicates, pigments and polymers. Preference is given to using microparticles which have a particle diameter of from 0.02 to 100 μm, more preferably from 0.1 to 50 μm and most preferably from 0.1 to 30 μm. It is also possible to use microparticles with diameters of less than 500 nm. However, microparticles which are composed of primary particles to form agglomerates or aggregates having a size of from 0.2 to 100 μm are also suitable.

The microparticles used, in particular particles which have an irregular fine structure in the nanometer range on the surface, are preferably particles which comprise at least one compound selected from fumed silica, precipitated silicas, aluminum oxide, mixed oxides, fumed and/or doped silicates and pulverulent polymers. As the result of the irregular fine structure in the nanometer range on the surface, preferred particles have elevations on the surface which have an aspect ratio of greater than 1, more preferably greater than 1.5 and most preferably greater than 2.5. The aspect ratio is in turn defined as the quotient of the maximum height to the maximum width of the elevations.

The microparticles preferably have hydrophobic properties which may result from the material properties of the materials themselves present on the surfaces of the particles or else be obtained by treating the particles with a suitable compound. The particles may be provided with hydrophobic properties before or after impression into the surface.

To hydrophobicize the microparticles before or after the impression (anchoring) into the surface of the injection molding, the microparticles may be treated with a compound from the group of alkylsilanes, fluoroalkyl-silanes and disilazanes, as available, for example, with the name Dynasilan from Degussa AG. The compounds mentioned may also be used to change the surface chemistry and the surface properties in areas of the surface of the devices according to the invention.

The microparticles used with preference are explained in more detail hereinbelow. The particles used may come from various categories. For example, they may be silicates, doped silicates, minerals, metal oxides, aluminum oxide, silicas or fumed silicates, Aerosils® or pulverulent polymers, for example spray-dried and agglomerated emulsions or cryogenically milled PTFE. Useful particle systems are in particular hydro-phobicized fumed silicas, known as Aerosils. To generate the self-cleaning surfaces, hydrophobicity is necessary as well as the structure. The particles used may themselves be hydrophobic, for example PTFE. The particles may have been provided with hydrophobic properties, for example Aerosil VPR 411® or AerosilR 8200®. However, they may also be subsequently hydrophobicized. It is unimportant whether the particles are hydrophobicized before application or after application. Examples of such particles to be hydrophobicized include Aeroperl 90/30®, Sipernat silica 350®, Aluminum oxide C®, zirconium silicate, vanadium-doped or Aeroperl P 25/20®. In the latter case, the hydrophobicizing is advantageously effected by treatment with perfluoroalkylsilane compounds and subsequent heat treatment.

It can be advantageous if the devices according to the invention have elevations applied to an overstructure having an average height of from 10 μm to 1 mm and an average separation of from 10 μm to 1 mm. The devices according to the invention for storing, in particular for temporarily storing liquids may be, for example, containers, vessels, bottles, ampoules, pipettes, pipette tips, sealable capsules, reaction vessels, titer plates, in particular microtiter plates or the like.

An example of a possible application of containers according to the invention is in biotechnology: valuable peptides and other biological substances are customarily stored in “Eppendorf” capsules (sealable capsules). These storage containers are customarily produced from polyethylene and have a capacity of a few 100 μl to a few ml. A sealing system allows these containers to be sealed and optionally deep-frozen. Owing to the storage conditions, the liquid substance generally accumulates randomly distributed on the surfaces. However, for complete sample withdrawal, accumulation of the substance at one point is desirable. The invention described can provide assistance here. The inventive microstructuring of the inner surfaces makes it possible for the entire substance to collect at the lowest point of the container and to be available for complete withdrawal. Reaction vessels or microtiter plates can also be provided with the inventive microstructuring of the inner surfaces. This permits complete emptying of the vessels which may also serve as intermediate storage for chemical substances in screening.

However, the use of the device according to the invention in environmental protection when using toxic substances is also conceivable. Furthermore, it is also possible to produce storage containers for medicaments having a parenteral dosage form whose inner surfaces have microstructuring.

The invention is illustrated in more detail with the aid of the figures FIG. 1 to without being restricted thereto.

The figure FIG. 1 is a diagram of the surface of a pipette X which has particles P (for simplification of the diagram only one particle is shown). The elevation which is formed by the particle itself has an aspect ratio of about 0.71, calculated as the quotient of the maximum height of the particle mH which is 5, since only that portion of the particle which protrudes from the surface of the pipette X contributes to the elevation, and the maximum width mB, which in comparison is 7. A selected elevation of the elevations E which are present on the particles as a result of the fine structure of the particles has an aspect ratio of 2.5, calculated as the quotient of the maximum height of the elevation mH′ which is 2.5 and the maximum width mB′, which for comparison is 1.

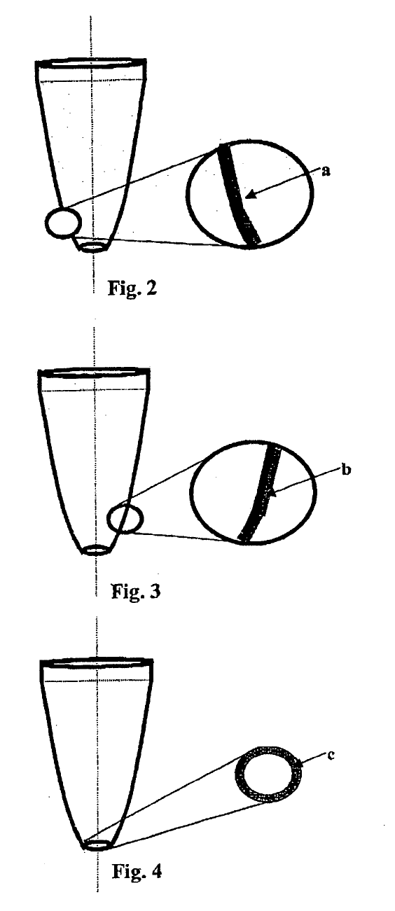

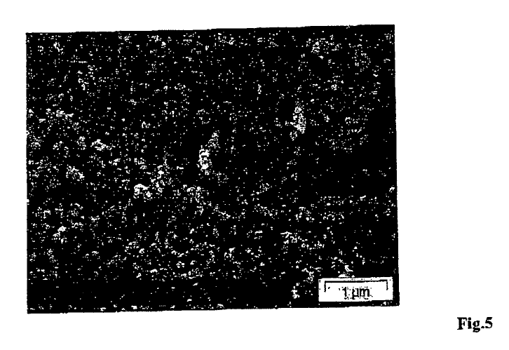

As can be seen with reference to the figures FIG. 2 to FIG. 4, the structuring, i.e. the elevations, can be applied to the interior (a in FIG. 2) or to the exterior surface of the pipette tip (b in FIG. 3). It is also possible to apply the elevations only to the end of the pipette tip, i.e. to the pipette outlet (c in FIG. 4).

The figure FIG. 5 shows a scanning electron micrograph (SEM) of a surface of a pipette tip which has a surface modified according to example 1. The picture shows an even distribution of the particles on the surface which are firmly anchored in the set polymer composition. It is remarkable that no orientational direction of the particles, which would be expected as a result of the movement of the polymer melt along the mold, is discernible. In comparison to nonstructured pipette tips, volumes could be pipetted which are smaller by at least a factor of 10.

The process according to the invention is described with the aid of the example which follows without the invention being restricted to this exemplary embodiment.

### Example 1

A suspension of 1% by weight of Aerosil R8200 in ethanol is applied to an injection mold for pipette tips and the solvent is then evaporated at 60° C. The injection mold prepared in this manner was used to produce an injection molding from polyethylene at a temperature of 60° C. and a pressure of 90 bar using an injection molding machine (ES150/50, Engel). The surface of the injection molding obtained from the injection mold had impressed particles, more than 50% of which were anchored in the surface by from 30 to 40% of their diameter. The smallest volume for a water droplet which could be pipetted using the injection molding produced in this manner was determined. It was shown that even droplets having a volume of 0.5 μl were released unaided from the tip.

### Example 2

Medicaments which are administered intravenously or subcutaneously are stored in ampoules or small containers. The ready-to-use solution rarely exceeds 1 ml. As a result of shaking, small droplets always accumulate on the surfaces of these containers. When withdrawing the liquid with a needle, these droplets frequently remain on the walls and thus reduce the available solution by up to 10%. In the case of medicaments, this results in a relative high dosing accuracy and, in the case of very valuable solutions, sometimes a large economic loss.

When the injection molds which are used for producing the storage containers are sprayed beforehand with a suspension of 1% by weight of Aerosil in ethanol, the containers no longer have these disadvantages. No residues remain adhering to the surfaces and the entire amount of liquid can be withdrawn.

1. A device for storing and/or handing at least one liquid, produced by injection molding
wherein the device has at least one surface which comes into contact with the at least one liquid to be stored,
the surface has a firmly anchored layer of microparticles which form elevations
and the liquids stored in the device are capable of being emptied without leaving a residue.

2. The device as claimed in claim 1, wherein the elevations have an average height of from 20 nm to 25 μm and an average separation of from 20 nm to 25 μm.

3. The device as claimed in claim 1, wherein the elevations have an average height of from 50 nm to 4 μm and/or an average separation of from 50 nm to 4 μm.

4. The device as claimed in claim 1, wherein the elevations which are formed by the microparticles have an aspect ratio of from 0.3 to 0.9.

5. The device as claimed in claim 1, wherein the microparticles are nanostructured microparticles which have a fine structure having elevations having an aspect ratio of greater than 1.

6. The device as claimed in claim 1, wherein the microparticles are selected from the group consisting of particles of silicates, minerals, metal oxides, metal powders, silicas, pigments, polymers and mixtures thereof.

7. The device as claimed in claim 1, wherein the microparticles are selected from the group consisting of particles of fumed silicas, precipitated silicas, aluminum oxide, silicon oxide, doped silicates, fumed silicates, pulverulent polymers and mixtures thereof.

8. The device as claimed in claim 1, wherein the microparticles have hydrophobic properties.

9. A device as claimed in claim 1, wherein the device s comprises a material selected from the group consisting of polycarbonates, polyoxymethylenes, poly(meth)acrylates, polyamides, polyvinyl chloride, polyethylenes, polypropylenes, aliphatic linear or branched polyalkenes, cyclic polyalkenes, polystyrenes, polyesters, polyether sulfones, polyacrylonitrile or polyalkylene terephthalates, poly(trifluoroethylene), poly(vinylidene fluoride), poly(chlorotrifluoroethylene), poly(hexafluoropropylene), poly(perfluoropropylene oxide), poly(fluoroalkyl acrylate), poly(fluoroalkyl methacrylate), poly(vinyl perfluoroalkyl ether), polymers of perfluoroalkoxy compounds, poly(isobutene), poly(4-methyl-1-pentene), polynorbornene as homo- or copolymers and mixtures thereof.

10. The device as claimed in claim 1, wherein the microparticles are anchored with from 10 to 90% of their average particle diameter within the surface.

11. The device as claimed in any claim 1, wherein the microparticles have an average particle size (diameter) of from 0.02 to 100 μm.

12. The device as claimed in claim 1, wherein the device is a pipette tip, a pipette, a syringe, a plastic ampoule, a vessel, a reaction vessel, a sealable capsule or a microtiter plate.

13. A process for producing the device as claimed in claim 1, the process comprising:
applying the microparticles to a mold and then
injection molding a material into the mold
wherein the microparticles are impressed into the surface of the material,
the device has at least one surface having self-cleaning properties and the device has elevations formed by the microparticles.

14. The process as claimed in claim 13, wherein the microparticles are impressed into the device to a maximum of 70% of their diameter.

15. The process as claimed in claim 13, wherein the material is a polymer or polymer blend comprising polycarbonates, poly(meth)acrylates, polyamides, polyvinyl chloride, polyethylenes, polypropylenes, aliphatic linear or branched polyalkenes, cyclic polyalkenes, polystyrenes, polyesters, polyether sulfones, polyacrylonitrile or polyalkylene terephthalates, poly(trifluoroethylene), poly(vinylidene fluoride), poly(chlorotrifluoroethylene), poly(hexafluoropropylene), poly(perfluoropropylene oxide), poly(fluoroalkyl acrylate), poly(fluoroalkyl methacrylate), poly(vinylperfluoroalkyl ether), polymers of perfluoroalkoxy compounds, poly(isobutene), poly(4-methyl-1-pentene), polynorbornene as homo- or copolymers or mixtures thereof.

16. The process as claimed in claim 13, wherein the mold is capable of producing conventional injection moldings.

17. The process as claimed in claim 13, wherein said applying the microparticles is carried out by spraying.

18. The process as claimed in claim 17, wherein said applying the microparticles is carried out by
applying a suspension which comprises the microparticles and a solvent to the mold and then evaporating the solvent.

19. The process as claimed in claim 17, wherein said applying the microparticles is carried out by applying an aerosol which comprises the microparticles and a propellant gas.

20. The process as claimed in claim 13, wherein the injection molding is carried out at a pressure of greater than 40 bar.

21. The process as claimed in claim 13, wherein the microparticles have an average particle diameter of from 0.02 to 100 μm.

22. The process as claimed in claim 13, wherein the microparticles are selected from the group consisting of silicates, minerals, metal oxides, metal powders, silicas, pigments, polymers and mixtures thereof.

23. The process as claimed in claim 13, wherein the microparticles have hydrophobic properties.

24. The process as claimed in claim 13, wherein the microparticles are treated with a suitable compound to provide hydrophobic properties.

25. The process as claimed in claim 24, wherein the microparticles are provided with hydrophobic properties before or after binding to the surface of the material.

26. The device as claimed in claim 1, wherein the device is capable of being utilized for temporary storage of blood, liquid medicaments, drugs, drug replacements, bioassays, proteins, peptides, biopharmaceuticals, nucleic acids and/or liquid solutions thereof.
